(19) United States
(12) Patent Application Publication
(10) Pub. No.: US 2024/0193695 A1
(43) Pub. Date: Jun. 13, 2024

(54) MODULAR SYSTEM AND TOOLS FOR EQUITABLE ACCESS TO STANDARD OF LIVING AND ECONOMIC OPPORTUNITIES

(71) Applicant: AGT LLC holdings, Plymouth, MN (US)

(72) Inventor: Girma Wolde-Michael, Plymouth, MN (US)

(21) Appl. No.: 18/534,785

(22) Filed: Dec. 11, 2023

Related U.S. Application Data
(60) Provisional application No. 63/387,096, filed on Dec. 13, 2022.

(51) Int. Cl. G06Q 40/06

(52) U.S. Cl. CPC G06Q 40/06

(57) ABSTRACT

A modular system and tools to manage access to standard of living, quality of life benefits, and reduce social vulnerabilities in underserved communities. The disclosure includes client applications, specialized tools and hosted services. Data analytics, modified Lorenz curves, and vulnerability metrics are implemented to design, measure, monitor and provide tools for use by policy makers, developers, and service providers. Optimization algorithms, artificial intelligence (AI) and internet of things (IOT) are integrated with public and private, and real-time infrastructure data for equitable access to economic benefits and opportunities. Further, nodes are implemented to provide customized tools focused on clients' needs. An AI-enabled application supports seamless access to the system for clients to operate customized tools and hosted services, while elastically learning and responding to individual client needs, supporting effective evaluation and management of public and private investments, and providing tools to implement equitable and effective policy and investment decisions.

### CROSS-REFERENCE TO RELATED APPLICATIONS

The present application claims the benefit of priority under 35 U.S.C. § 119(e) of U.S. Provisional Application No. 63/387,096, entitled MODULAR SYSTEM AND TOOLS FOR EQUITABLE ACCESS TO STANDARD OF LIVING AND ECONOMIC OPPORTUNITIES, filed Dec. 13, 2022, the content of which is hereby incorporated by reference in its entirety for all purposes.

### BACKGROUND OF THE INVENTION

Inadequacies of incumbent public and private infrastructure systems, hospitals, clinics, health care systems, schools, and lack of several other standard of living essentials in underserved communities are the outcome of a self-organizing and exclusionary social construct which aggregates communities and separates them by economic and other systemic social distinctions. Specifically, this prevailing condition in the US and other global communities results in unequal benefits and poor quality of living standards and renders certain communities perpetually vulnerable. In the US, for example, the negative burden of the current public and private transportation system and inadequacy of infrastructure falls on people who are disinvested and, as a result, live in marginalized communities. Existing transportation and other necessary standard of living essentials need practical systems to assess and implement both public and private investments, with a view to reduce vulnerability, and foster equity and fairness. Given the existing disparities in infrastructure and associated benefits across communities, the problem is likely to persist. Further, to expect immediate improvements is impractical because it would require a multi-year commitment of government and private investments to effect change. At best, it would likely be both practical and affordable to anticipate a gradual improvement overtime. However, the current disparity in equitable access and its attendant impact on standard of living and benefits, can be substantially improved by using modern communication systems and tools tailored to serve as a bridge into the future, as well as a catalyst to accelerate change.

As used in this disclosure, standard of living is a comparison tool to describe two or more geographic areas using various metrics. These metrics include, as an example, wealth levels, comfort, goods, services, and necessities that are available to members of different socioeconomic classes in a geographic area, community zone or region. Standard of living is measured by things that are quantifiable, such as income, employment opportunities, cost of goods and services, and poverty. Further, other factors commonly associated with the standard of living measurement include class disparity, quality and affordability of housing, hours of work required to purchase or acquire necessities, GDP (gross domestic product), affordable access to quality healthcare, quality and availability of education, incidence of disease, infrastructure including basic physical system of a region or community zone, and environment. Examples of infrastructure includes, but not limited to, transportation systems, communication networks, sewage, water, environmental safety facilities, public service systems such as parks, recreational facilities and the like, environmental quality, and safety within a community.

A lack of consideration of fairness, for example, in transportation and community planning decisions often negatively impacts underserved communities and denies access to benefits of standard of living that should readily be available. Equity analysis of standard of living of a community can be difficult because there are several types of equity, many potential impacts to consider, various ways to measure impacts, and many possible ways to categorize communities or people. Therefore, there is a need to provide tools, such as the system disclosed herein that implements the use of a modified Lorenz curve, vulnerability assessment tools and adjustment factors to assess and design effective infrastructure and implement necessary services using smart networks and tools, to enable access for underserved communities.

New technologies provide the potential to improve most of the existing disparities. For example, studies have shown that households in the bottom 90 percent income bracket spend twice the amount on transportation than households in the top 10 percent income bracket. Further, studies have shown that pedestrian fatality rates among African Americans are 60 percent higher than whites, and for Latinos it is about 43% higher than whites. Specifically, moderate and low-income Americans spend a substantially higher portion of their incomes on transportation expenses, have the lowest rates of single occupancy vehicle use, and highest usage of travel modes such as carpooling, transit, biking and walking. Workers in low-income households also have higher average commute distances relative to higher income households, reflecting their distance from employment opportunities in denser urban areas. These disparities are compounded by issues such as disability status and the legacy of racial segregation in many American cities which result in substantially lower standard of living.

Access to transport and other essential community services, as a standard of living, is unique because it is not usually regarded as a basic right or even one of the fundamental needs. However, for example, access to transportation impacts the lives of low-income households as it provides connectivity between all vital economic, social and personal activities on a daily basis. All modern societies require transportation of people and goods. The absence of a suitable, affordable and accessible transportation and transit infrastructure discriminates against those communities with perhaps the greatest need for it. Further, where the transportation infrastructure and communication systems are poor, generally the environment and other community services are correlatively poor.

As modern infrastructures and services become artificial intelligence (AI) centric, it is possible to design a system that ensures fair and equitable access to people and businesses who have historically been marginalized. Emerging tools and technologies like smart systems, machine learning, internet of things (IOT) and advanced communication systems can be used to revamp, for example, existing transportation systems and reduce commute times, increase commute options, increase household savings, and reduce time spent in commuting. For millions of Americans transport equity is not just about transport or mobility but a part of a standard of living. More significantly, the emerging trends of megacities and the attendant dense urbanization environments present a compelling need to consider standard of living benefits by making all essential services efficient, available, accessible and affordable for all.

A pragmatic AI-centric infrastructure and community service platform must focus on optimizing standard of living and associated benefits. For example, in the case of transportation, creating a service which considers the complete trip and enables the convergence of technology and mobility must be an essential aspect of the design or development policy. The Accessible Transportation Technologies Research Initiative (ATTRI) of the U.S. Department of Transportation (USDOT) has defined a complete trip as consisting of five major stages. A complete trip includes several modular sub-systems or trip stages that begin with trip planning and end with the traveler's arrival at their destination. Depending upon the traveler's profile, choices and available options at each stage of the trip, a traveler's use and need for information may vary. The USDOT program assessing existing standards which relate to multimodal and accessible travel provide a detailed list of a complete trip which starts with the activity of a preparation stage and ends with a final destination. While the ATTRI initiative has detailed plans, it will need additional tools such as the modified Lorenz curve analysis disclosed herein, to more fully review and evaluate the effectiveness of proposed policies and or investments. Further, there is a need to assess the social impact using vulnerability metrics disclosed herein.

Inclusive, accessible systems and services will continue to play a major role in government policy, particularly as transportation technology advances and more mobility services and options are available to consumers. Specifically, user needs must drive transport design and associated community development to become more accessible and equitable. For example, in most transport and mobility systems, the technology-enabled services that are critical to meeting equitable transport development, and for which applications are being piloted, include personal assistant applications such as wayfinding and navigation; pre-trip concierge and virtualization; safe intersection crossing; and robotics and automation. In addition, from an automated vehicle perspective, machine vision, artificial intelligence (AI), assistive robots and facial recognition software will be facilitating travel for persons with disabilities. Further, in terms of equity and inclusion, in the near future, the integration of technology and social/government policy will need a focus on addressing transportation and associated equity in view of personal applications and individual empowering technologies.

A successful technology framework needs to include variables such as Spatial, Temporal, Economic, Physiological and Social (STEPS) as well as communal factors to design a well-considered equitable service for societal benefits. For example, in addition to mobility, standard of life considerations which include, without limitation, multiple aspects of benefits afforded to an individual who reside in a certain zone or community must be considered. In order to implement such framework, there is a need for technology systems and tools that can assess opportunities and challenges in view of policies and existing infrastructure that can be used to successfully implement solutions for marginalized communities, disabled, low-income, elderly, and medically challenged individuals. The modified Lorenz curve and various tools of the present disclosure provide a practical system for use to enable access to services tailored to give disadvantage communities and individuals equitable access to benefit form a higher standard of living.

In the relevant art, U.S. Pat. No. 9,047,384 to Barbeau et al., entitled System and Method for Automatic trip purpose detection, the patent discloses an automated trip-purpose detection method that utilizes GPS Data collected by GPS-enabled devices. The GPS data is compared against a GIS map to obtain various spatial and location characteristics of the surrounding area. This information is then used to derive a traveler's trip purpose. In a preferred embodiment, the inventive method is implemented automatically without any needed manipulation of GIS data. Additionally, the method integrates location information as defined by the user for critical locations such as home and work. These personalized locations allow the method to immediately identify the two most common types of trips: work-related trips and trips returning home.

Further, in another relevant art, U.S. Pat. No. 8,924,536 to Barbeau et al., discloses a distributed and decentralized location-aware system that includes a number of peers, each in communication with other peers and adapted to communicate PING, PONG, and ALERT messages. Each of the messages has a header that includes location information. Also provided is a method of communication between two peers in the system. In addition, the invention includes a method of rendering the system. In the method, a communication link between an electronic map and a number of peers is provided. The location information and the covering distance of each of the peers are obtained and used to plot the location and render the covering distance of each peer on the electric map. A communication link between an electronic control device and the electronic map is also provided.

Yet another relevant art disclosed in U.S. Pat. No. 8,843,315 to Barbeau et al., deals with a spatial data processing system and method that allows the automatic, rapid, scalable analysis and transformation of large amounts of travel behavior data (e.g., tracking data points) into individual “points-of-interest” and discrete trips stored in a spatial database. Each trip has a point-of-interest as a starting and ending location and contains multiple positions (e.g., latitude and longitudes) which define the travel path of the user/device during that time period.

Further, U.S. Pat. No. 8,751,162 to Barbeau et al., discloses a prediction method that estimates the real-time position of a mobile device based on previously observed data. The invention can be used in real-time navigation, including providing real-time alerts of an upcoming destination and notifications of emergency events in close geographic proximity. The prediction method utilizes neural networks and/or functions generated using algorithms in estimating the mobile device's real-time position. The prediction method provides reliable Location-Based Services (LBS) in events where traditional positioning technologies become unreliable. It is seamless, as the user remains unaware of any interruption in accessing the positioning technology.

U.S. Pat. No. 8,725,831 entitled Architecture and Two-Layered Protocol for Real-Time Location-Aware Applications discloses a two-layered communication protocol that supports efficient real-time location-aware application on multiple mobile devices that must communicate with each other and/or a centralized server. The two-layer protocol includes a method of communicating data between a first mobile device and a second mobile device using a server to facilitate the communication of the data. The two-layer communication protocol also includes a method of communicating data between a first mobile device and a second mobile device using a server to facilitate the connection between the two mobile devices. Each method uses reliable, connection-oriented protocols to exchange application-level information and control signals while utilizing unreliable, connection-less protocols to communicate real-time location data. Also provided are architectures implementing these methods.

Further, U.S. Pat. No. 8,169,342 deals with method of providing a destination alert to a transit system rider. The patent teaches algorithm used in the Travel Assistance Device (TAD) system to alert a transit rider when to exit the bus based on their real-time location and nearby bus stops.

U.S. Pat. No. 8,145,183 relates to an on-demand emergency notification system using GPS-equipped devices and provides mobile app to automatically determine the cell phone user's current evacuation zone and real-time evacuation information for that zone. Further, related to personal service, U.S. Pat. No. 8,140,256 provides a dynamic ride-matching algorithm and a GIS-based Algorithm to match riders for carpools that are traveling on similar routes.

Furthermore, U.S. Pat. No. 8,138,907 Travel Assistant Device Travel Assistance Device (TAD) system to assist transit riders with intellectual disabilities. Moreover, U.S. Pat. No. 8,045,954 teaches a Wireless Emergency-Reporting System and discloses a bidirectional location-based multimedia messaging system. Further, U.S. Pat. No. 8,036,679 teaches Optimizing performance of location-aware applications using state machines. Specifically, dynamically adjusting GPS sampling rates are implemented to allow high resolution tracking while moving, and conservation of battery energy when stopped.

In a relevant art, U.S. Ser. No. 10/095,759, discloses a data engine integration and data management system. The system includes receiving, by an in-memory engine, a request for data. The data is transmitted, by the in-memory engine and to a metadata storage unit, that is associated with the request. The operation includes receiving metadata and determining a first amount of processing to be performed by the in-memory engine and a second amount of processing to be performed by a data engine. Further, the operation includes transmitting a request (i) for a first portion of unprocessed data and (ii) to perform a second amount of processing on a second portion of unprocessed data. Moreover, these operations include receiving the first portion of unprocessed data and the second portion of processed data. Subsequently, the operation processes the first portion of unprocessed data, and ultimately presents a group of the first portion of processed data, and the second portion of processed data.

Yet another relevant art, Pub. No. US 2005/0055329 A1, Data base management system having data aggregation module integrated therein discloses a method of aggregation data including a high-performance aggregation module integrated into a data base management system. The system can be used to support on-line analytical processing operations or to realize and improved informational database system, operational database system or the like.

While the prior art teaches various approaches in data management focused on transit or other operations involving large data management, and integration and processing systems, there is a need for a comprehensive smart equity-based platform to optimize the standard of living in a community by providing specialized tools, hosted third party services and client specific applications. Specifically, the present disclosure provides various tools, processes and capabilities to implement equitable and efficient system of access to mobility and other necessary community services, with a view to enhance benefits and improve the standard of living for all citizens. Further, the present disclosure provides tools for policy makers, private developers and investors to forecast, measure and monitor the effectiveness and or positive outcomes realized by a target community and residents. Moreover, the modular system and tools of the present disclosure utilize AI enabled operations and can elastically learn to continuously adapt to changing standard of living requirements, with a focus on diverse client and community needs to attenuate vulnerabilities and equitably optimize standard of living and economic opportunities.

### SUMMARY

This section provides a general summary of the disclosure. It should be noted that this is neither a comprehensive presentation nor a full scope of all the features of the disclosure.

The present disclosure relates to the implementation of a modular system and tools which use a data management system to process raw data with the ultimate objective to provide client specific applications, in conjunction with specialized tools and hosted services.

Specifically, the client application provides user interface and access to data tailored, for example, to one or more residents in a certain community. The client application includes interactive tools to enable the client to communicate and operate various system tools and engage with a diverse set of personal assistant devices such as a server, PC or mobile phone. The client may access for example, transportation, healthcare, and related client-specific services. The specialized tools include, without limitation, a customization platform to assimilate new data arising from a dynamically changing data environment. The customization platform also provides tools and methods to aid in the evaluation and follow-up of the effectiveness of public and private investments and policies by considering vulnerability factors to equitably avail standard of living benefits and economic opportunities to a target community. For example, the disclosure includes modified Lorenz curve and vulnerability simulation tools (VST) to design, track and monitor the effectiveness of certain investment and or policy in advancing equity and improving the standard of living in underserved communities. Further, the hosted services platform is structured to host and enable third party service providers to handshake, engage with and use the modular system tools and platform.

### DRAWINGS

The description of the drawings herein below is for illustrative purposes with only selected embodiments presented to describe the invention. Accordingly, the drawings in part or in whole do not represent all possible implementations and are not intended to limit the scope of the present disclosure.

FIG. 1 is a layout of a modular data management platform showing the stages of data integration, data refinement, data processing and system implementation architecture of the present disclosure.

FIG. 2 shows a conceptual depiction of community envelopes and distinct zones representing overlapping boundaries and characteristics for various communities in a contiguous landscape.

FIG. 3 Shows a smart mobility system integrated with the modular data management system of FIG. 1.

FIG. 4 is a typical layout of a memory banks implemented in the modular system of the present invention.

FIG. 5 is a high-level functional block diagram of a multiprocessor computer architecture as used in the present invention.

FIG. 6 is a flow chart illustrating an example process of the transformation of raw data to effect system implementation.

FIG. 7 is a high-level functional diagram of data exchange and connectivity between the Data Management System of the present disclosure and various independent data clusters.

FIG. 8 is a flow chart illustrating an example process of the transformation of raw data, such as demographics and personal information to provide the necessary services.

FIG. 9A is a representation of an AI-enabled infrastructure communication scheme showing wireless interactions between an IOT including wearable devices on a pedestrian, infrastructure, and a vehicle in various states of motion.

FIG. 9B is a representation of the communication network for client application outside the community envelope showing wireless data communications between the modular system, cloud services, a handheld user device, and various service platforms.

FIG. 10 is a block diagram showing the transmission of information via the data management platform wherein data is tailored to be received by the user platform adapted to be received by various wireless enabled smart user devices.

FIG. 11A is a depiction of a dual Lorenz curve with Causal Factors and Benefits on opposite Y-axes, and Population on the X-Axis.

FIG. 11B is a depiction of a dual Lorenz curve with Income and Benefits on the Y-Axes, and Population on the X-axis.

FIG. 11C is a depiction of dual Lorenz curves showing varying levels and or different types of benefits under consideration to determine adjustment factors or impacts thereof.

FIG. 11D is a depiction of a vulnerability simulation tool (VST) and associated Lorenz curve for the assessment to measure impact of income on exposure to vulnerability factors under consideration.

FIG. 12 is a depiction of system configuration to integrate processing outputs to specific applications

### DETAILED DESCRIPTION

Example embodiments will now be described more fully with the reference to the drawings.

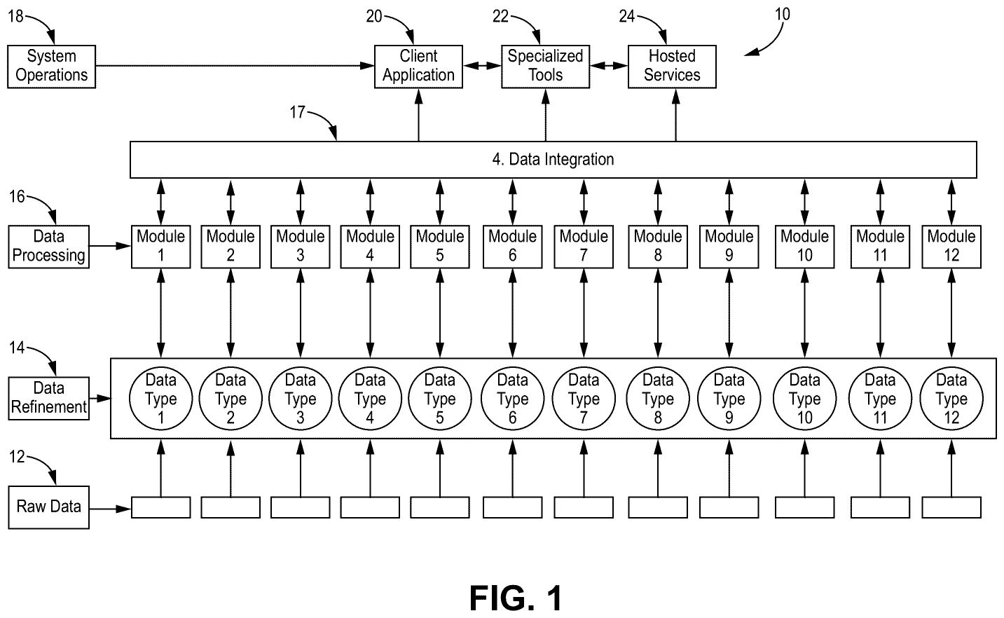

FIG. 1 shows a general layout and architecture of the modular system 10, in which unprocessed data or raw data12 is collected. Data 12 is refined at data refinement stage 14 based on the objective downstream, and data 14 is processed at data processing 16. Thereafter, the data goes through data integration 17. System operations 18 provides data platforms for Client application 20, specialized tools 22, and hosted services 24 all which are in bi-directional communication with each other as well as with data integration platform 17, and system operations 18.

Client application 20 includes application running in a user's device, without limitation, such as a mobile phone, PC, Mac, and workstation. Specialized tools 22 enable customization of data. Specifically, under specialized tools 22, customizable data can be harmonized with a currently observed related data which changes over time. This feature enables explicit customization of modular data management 10, to integrate, refine and process data in a dynamically changing data environment. Further, hosted services 24 operates as a platform enabling access to modular system 10 to specific users, for example without limitation, government policy makers, researchers and third party service providers.

Modular system 10 is structured to adapt and process organic raw data 12, for use to seamlessly handshake with various data sets and operations, and equitably provide access to standard of living benefits to clients based on specific client needs and choices. As an example, and without limitation, pervasive computing technologies are being used in the development of networked intelligent traffic and mobility management systems. Specifically, such systems enable the integration of telecommunication and related data which could be tapped to improve transportation and mobility, health services, and similar other standard of life necessities in underserved communities. Using specialized tools 22 to dynamically customize and harmonize a currently observed raw data, which changes over time, with existing data such as data type 1 for example, a new set of observed data could be integrated to adjust services or make modifications to any one of the factors which impact benefits associated with the standard of living of a community. Taking transportation equity as an illustrative example, modern cars have computers integrated with their various operations. Self-driving cars, for example, will integrate even more computer and artificial intelligence (AI) with a view to navigate through actively changing dynamic traffic systems. System operations 18 is structured to integrate with these types of existing and future transportation technologies. As is well known in the art, such a system would require a smart AI-enabled infrastructure that will seamlessly communicate with the self-driving cars and all kinds of intercommunicative traffic including pedestrians, cyclists and those who use mopeds and motorcycles. As this type of AI-enabled intelligent traffic environment grows and changes, modular system 10 is implemented to grow with it via the implementation of specialized tools 22, bringing access to information and tools that end user can reach through client application 20 or hosted services 24.

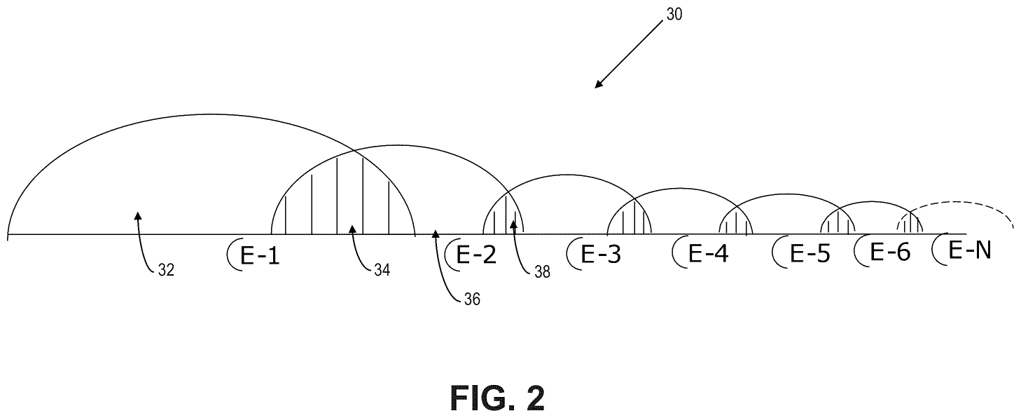

Referring now to FIG. 2, exemplary community envelope 30 is shown. Community envelope 30 is a geographical cluster of zones 32 and contiguous community zones 34. A community zone 36 may also comprise of multiple contiguous zones such as 34 and 38. The characteristic features of each envelope is defined and classified based on benefits measured, and on the basis of access to affordable and reliable transportation and other benefits such as for example, without limitation, education, employment, healthcare, housing standards, environmental safety and hazard controls, advanced infrastructure amenities, safety and security including participation in a vibrant healthy community with a high standard of living. Community envelope 30, is an information source for data which will give city planners and service providers parameters and data to create a more equitable benefits system. Specifically, data obtained from community envelope 30 could be compared and contrasted against both national, state, and local benefits associated with the standard of living across various urban and suburban communities. Such data can inform policy makers and investors to plan and deploy resources to achieve optimal desired outcomes.

As an illustrative example, transit systems of the future will need to maximize the amount of residential, business and leisure space within a walking distance of public transport. As discussed herein below, information and data extracted from exemplary community envelope 30, will be used to develop specific Lorenz curves to implement equity factors for the design and or allocation of equity adjustment means and tools in specific community zones such as community zone 32, for example. Data from community envelope 30 could also be used as a design and development tool to assess and allocate benefits on the basis of building density regulations, various traffic regulations including parking, specific locally focused urban design, and first and last-mile transportation services which support transit-oriented communities and discourage auto dependency. Further, client application 20 is structured to provide individual applications tailored to the needs of residents in view of the data collected from community envelope 30. The prevailing conditions in a community and the modified Lorenz curve adjustment factors, make up an effective tool to evaluate and design a system for equitable access to a targeted standard of living objective. Specialized tools 22 customize data collected from community envelope 30 and tailor it for use by clients in the community under client application 20. Similarly, customized data of community envelope 30 may be accessed by third party service providers under hosted service 24. Hosted service 24 enables access to specialized tools 22 under a secure user protocol to tailor services to either a community such as community envelope 30, or a specific resident in that community.

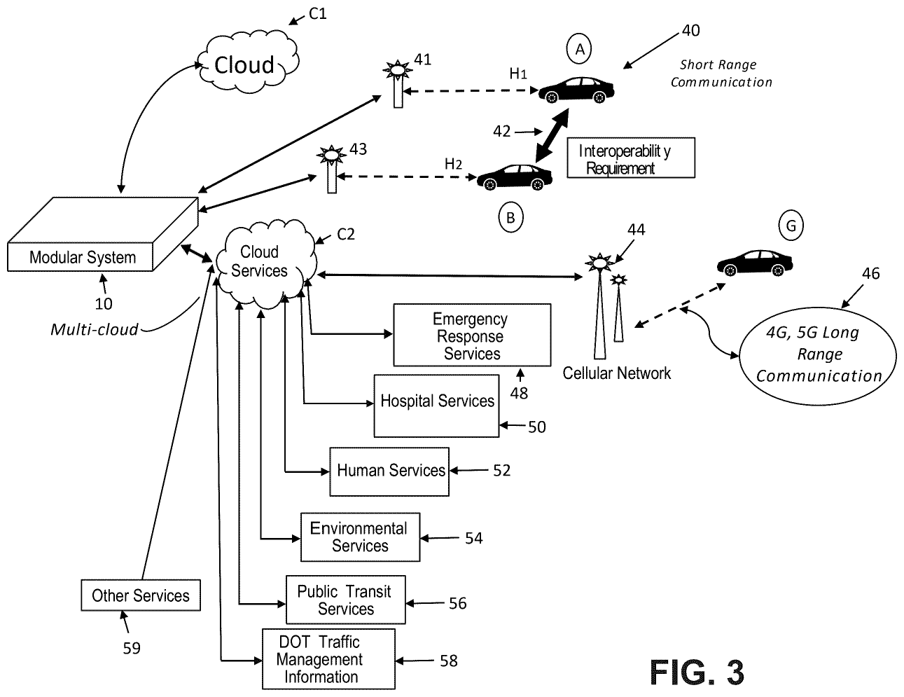

Referring to FIG. 3, exemplary wireless communication scheme 40 is shown integrated with modular system 10 of the present disclosure. An intelligent traffic system that will host self-driving cars and smart infrastructure will require a robust digital communication and analytics capabilities. Wireless communication system 40, is structured for an effective integration of infrastructure, autonomous vehicle, semiautonomous and cars with communication capabilities. Specifically, wireless communication system 40 is in communication with modular system 10 to enable end-user client access to optimize the functionality of a sustainable, elastic transportation service or other quality of life benefits. Exemplary traffic A and B are in short range bi-directional communication with each other via channel 42 and are interoperable. Traffic A is in bi-directional communication with cellular node 41, and traffic B is in a bi-directional communication with cellular node 43. Traffic G is in long range communication with cellular network 46 using 4 G or 5 G. Cellular networks 41 and 43 are in a bi-directional data communication with cloud services 44, respectively. Cloud services 42 is preferably private or hybrid cloud. Modular system 10 is in a bidirectional data communication with cloud services 42. Further, cloud services 45, which is a bidirectional data communication with modular system 10, is preferably multi-cloud managing hosted services 24 thus managing third party clouds in a heterogenous client environment. Accordingly cloud services 45 is in bidirectional data communications with various third party hosted services, such as emergency response 48, hospital services 50, human services 52, environmental services 54, public transit services 56, DOT traffic management information 58 and all other types of service or parties 59

In operation, dynamic traffic such as A and B are in short range communication with various elements of traffic, for example without limitation, such as cars, motorbikes, trucks, cyclists, mopeds, pedestrians, and the infrastructure using embedded sensors to communicate wirelessly using UWB, Wi-Fi, Zigbee and Bluetooth and other IT protocols. The communication range of any embedded sensor enables it to send and receive information with any other sensor located within the range region. Specifically, connected coverage protocols are employed to enable very dense wireless sensor networks. Cellular nodes 41 and 43 are in short range data communication via channels and communication signal lines C and D with traffic A and B, respectively. This arrangement provides real-time dynamic traffic data which is collected at a central node such as cellular nodes 41 and 43, to be analyzed or communicated to a processing center for analysis in modular system 10. Modular system 10 is in a two-way data communication with cellular nodes 41 and 43 via cloud services 44. The system also enables independent local traffic management.

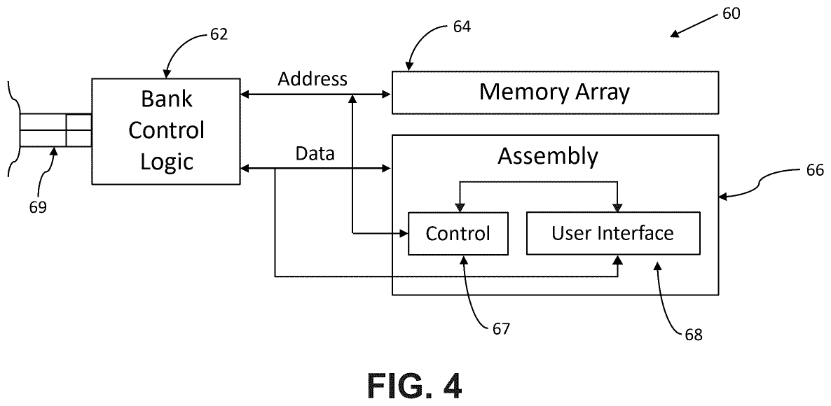

Referring to FIG. 4, a truncated multiprocessor computer system 60 is shown. The system includes a bank control logic 62, a memory array 64 and assembly system 66. All the processors on the various CPUs share a unique logical address space which is mapped on memory array 64 and is distributed among the various processors of computer system 60. Assembly 66 includes control 67 and user interface 69, both of which are in bidirectional communication with each other. Further, control unit 67 is in data communications with the address and user interface 68 which is coupled to the data to produce executable codes. Computer system 60 includes trunk line 69 representing a system structure which provides the option and capability to add as many microprocessors as needed.

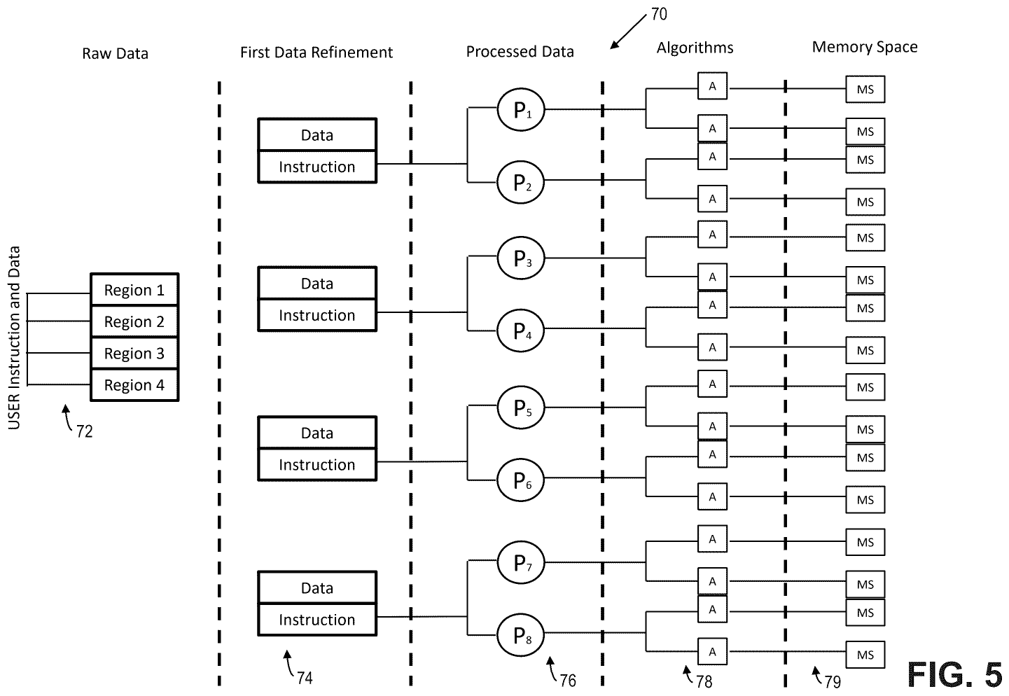

FIG. 5 is a functional block diagram of a standard multiprocessor computer architecture 70. User instruction and data which are privileged and non-privileged, separating the user mode from the system mode are entered as part of raw data classes at regional raw data set 72. Regional raw data set 72 is refined with specific instructions, under first data refinement types 74. Thereafter, the data is processed by parallel processors 76 associated with specific first data refinement types 74. Each set of processors 76 is associated with algorithms 78. Algorithms 78 are implemented to solve a required class of problems or to perform computations as needed. Subsequently, each algorithmic result is assigned a memory space 79. Thereafter, the various results are implemented, for example, to generate data and or information, with a view to provide client specific applications 20, engage and operate specialized tools and systems 22 and engage or interact with hosted services 24.

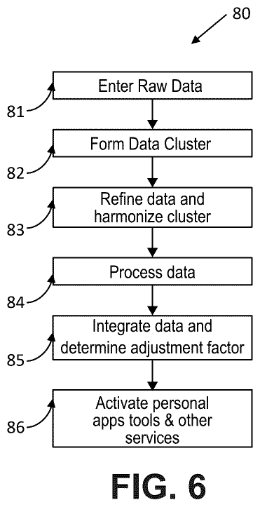

FIG. 6, is a flow chart 80 showing a typical raw data processing for system implementation. At step 81, raw data is entered. Subsequently a data cluster is formed at step 82. At step 83 data is refined and a harmonized cluster is processed. At step 84 the refined data is processed to be compliant to generate an adjustment factor for equitable access to benefits tailored to the specific needs of a client. As will be disclosed herein below, the adjustment factor is derived from a modified Lorenz curve analytic tool to determine the adjustment factor. Thereafter at step 85 the data is integrated consistent with the final objective, Specifically, at step 86 integrated data is processed to enable the user app to engage infrastructure tools and services as needed

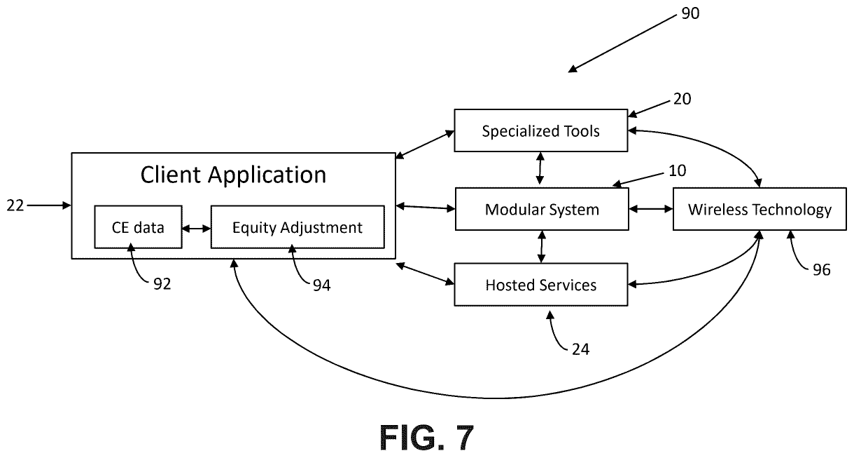

FIG. 7 is a high-level functional diagram of data exchange and connectivity between the modular system 10 and various independent data clusters. Data exchange network 90 includes Community envelope data platform 92, preferably nested in specialized tools platform 22. Community envelope data platform 92 comprises community income, conditions of infrastructure in the community envelope, and any data associated with income, consumption patterns, expenditure profile, and related statistics to support a comparative life standard based on a national or local equity or benefit adjustment parameter. Similarly, equity adjustment software tool 94 is nested in specialized tools platform 24. Specialized tools 22 is bi-directional data communications with modular system 10. Client application 20 and hosted services 24. Wireless technology 96 is in two-way communication with modular system 10, client apps20 and specialized tools 22.

Client services platform 94 includes individual tools provided to the client related to various client-based services and solutions. Equity adjustment factor tool 94 is in bi-directional data communications with community envelope data platform 92. Further, equity adjustment tools 94 includes, without limitation, various factors that are applied to specific conditions of a client. For example, as applied to mobility, equity adjustment tool 94 tailors information and assets to provide optimal mobility services that could best meet the needs of different types of clients. The equity model of the present disclosure is based on statistical data related to income and associated benefits for the community envelope 30 in one or more cluster of community envelopes. The system makes equity adjustments which is implemented for use in a specific client application for use in client services platform 20. Equity adjustment tools 94 is capable of adapting to various statistical data and tools to assess and determine the necessary actions to be taken to enable a community to reach a certain level of quality of life standard. In essence equity adjustment 94 could be adapted to manage equity at both the macroscopic (state, county, community) and microscopic (individual, community members) levels.

To illustrate the operational aspects of this disclosure and with reference to FIGS. 1 and 7, after raw data 12 is collected, it is refined at data refinement 14 by identifying and processing the type of required data in view of the downstream operation at data processing 16. And data integration 17 which may be direct into generic client application 20. Equity adjustment tool 94, refines generic client application 20, to provide specific client tools and services. Equity adjustment factors and parameters are implemented based on data compiled from CE data 92. As an example to determine equity in a transit system, the objective is to provide tools and services to individual clients, policy makers and investors to implement effective systems to enable a community or client achieve favorable cost and benefit positions in view of existing standards and available assets, As applied to equitable access and enjoyment of quality of life benefits, equity adjustment 94 includes without limitations, parameters for broad community access to mobility, traffic safety and associated infrastructure, reduction of air pollution and other environmental safety, affordable housing, community based economic opportunity catalysts, access to education and health care facilities, community life and leisure enhancement facilities, crime prevention and reduction tools, and personal safety and security.

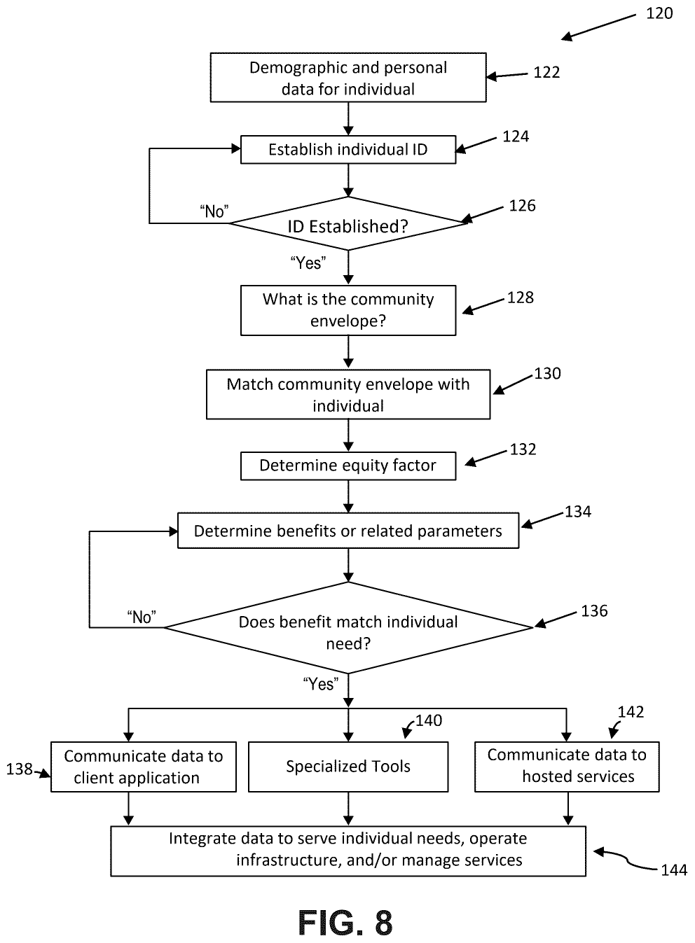

FIG. 8 is an algorithm flow chart 120 illustrating an exemplary transformation of raw data, such as demographics information from community envelope 30 and client (personal) data to provide the necessary services and tools to a user. Specifically, demographics and personal data for the user is entered to derive adjustment factor at step 122. Next, under step 124 the individual ID is established. At decision step 113, if the individual ID is not established the process enters a loop that prohibits moving forward to the next step. If proper ID is established at step 126, the process proceeds to step 128 where community envelope information is entered. Thereafter, the community envelope is matched with the individual ID at step 130. At step 134, the type of desired benefits are determined. At decision step 136, a check is made if the benefits match with the individual's needs within the given community zone conditions. If not, the algorithm goes into a loop where the process will not proceed unless there is a confirmation of the match. Thereafter, the algorithm proceeds to steps 138, 140, and 142 where the result is communicated and stored in one or more of data pools within client application 20, specialized tools 22, and hosted services 24. Specifically, at steps 138, the algorithm proceeds to individual's application platform or client application 20, at step 140 processed data is directed to specialized tools platform 22, and further at step 142 data is directed to hosted services 24. Also, the result is stored for use by various services at step 142 such as hosted services 24.

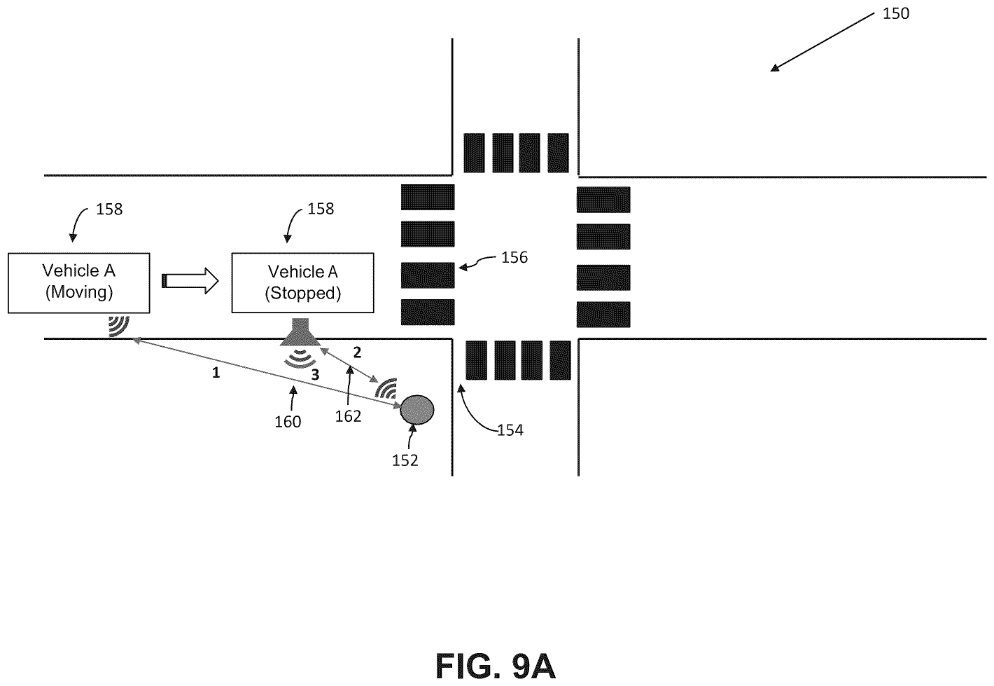

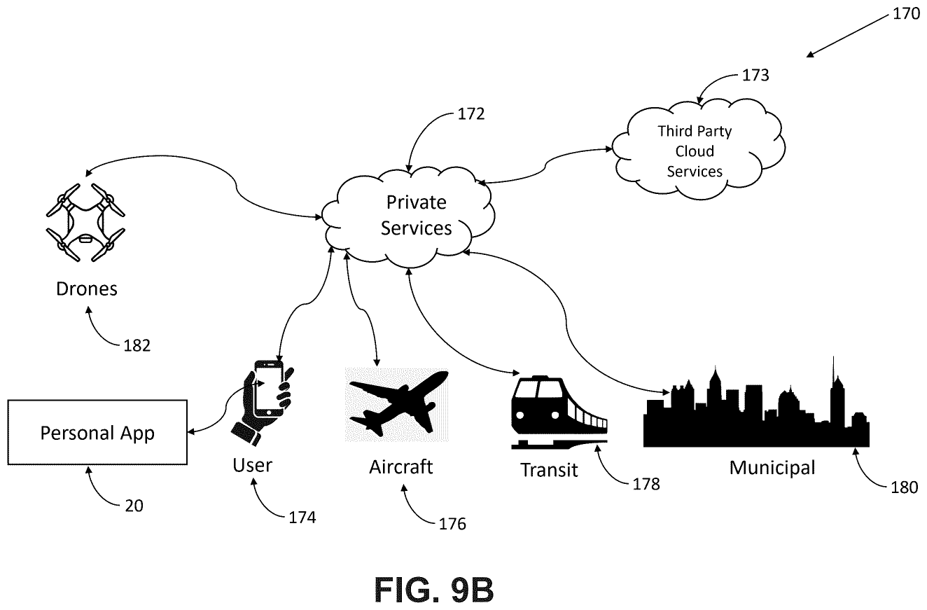

FIG. 9A is a representation of an AI-enabled infrastructure communication scheme. It should be noted that the various AI and IOT enabled systems, and associated communication and data management system could be used to implement equitable access to various quality of life enhancement needs of a community. In an exemplary AI and IOT-enabled traffic environment 150, Client or individual 152 is in wireless communication via channel 154 with infrastructure 156. Further, individual 152 is in wireless communication with vehicle 158 when it is in motion and or in a stationary position via channels 160 and 162, respectively. in a moving and fully stopped positions User application such as client application 20 is tailored to the, needs and is requests of individual 152 and enables navigation of a traffic 150 in an environment such as, community envelope 30.

FIG. 9B is a representation of the communication network for client application 20 outside the community envelope 30 where the client resides. Modular system 10, is in wireless data communication with cloud services 172. A handheld user device 174 is in a bidirectional data communication with client application 20. Client or end user device 174 is tailored to provide specific tools and applications tailored to end user 174. Thus, in addition to wireless communication with local dynamic traffic 150, end user 174 is enabled to access airline services 176, transit services 178, municipal private/public services 180 via cloud services 172 which is hosted by modular system 10 cloud services. One of the equity adjustment aspects of providing access, according to the present disclosure includes providing appropriate tools and technologies to clients to enable ease of access to available services, while keeping the needs of the individual as a critical factor in the design of the tools.

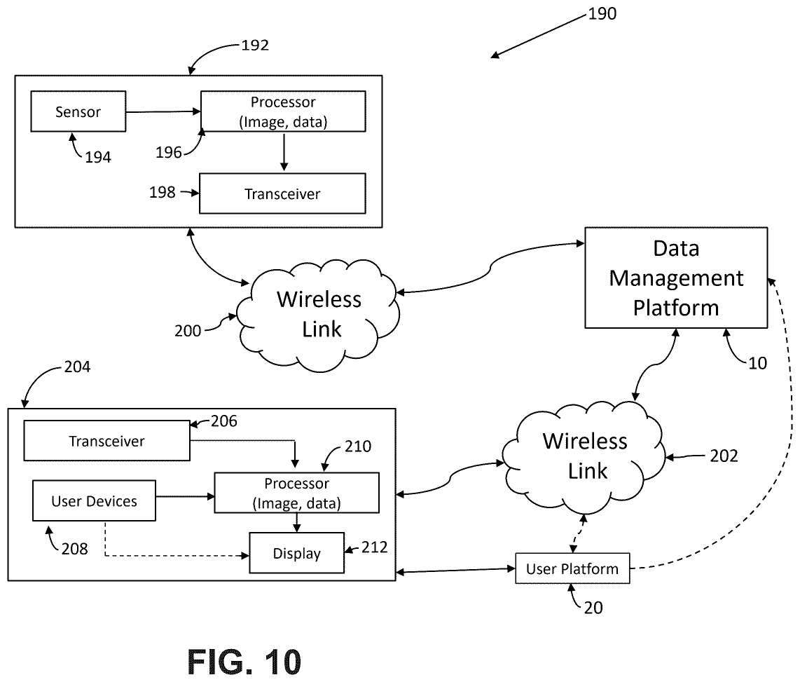

Referring now to FIG. 10, a block diagram showing data exchange and communication scheme 190 according to the present disclosure is presented. Specifically, data transmission system 192 collects information from hosted services 24 and provides data to modular system 10 via private, public or hybrid wireless data link 200. Exemplary data transmission system 192 includes sensor 194 in data communication with image and information processor 196 and transceiver 198. Similarly, modular data management 10 is in data communication with specialized tools 22, utilizing exemplary data exchange and communication platform 204, via a private wireless data link 202. Transceiver 206 transfers information and data to user device 208. Further, transceiver 206 is in bi-directional communication with processor 210, which in turn is in bidirectional communication with digital display alert 212. Client application 20, is in a bidirectional communication with private wireless data link 202. Alternatively, client application 20 is in direct bidirectional data communication with modular platform 10. Client application 10 includes a user platform which enables the user to access customized information as well as specialized tools 22, and hosted services 24.

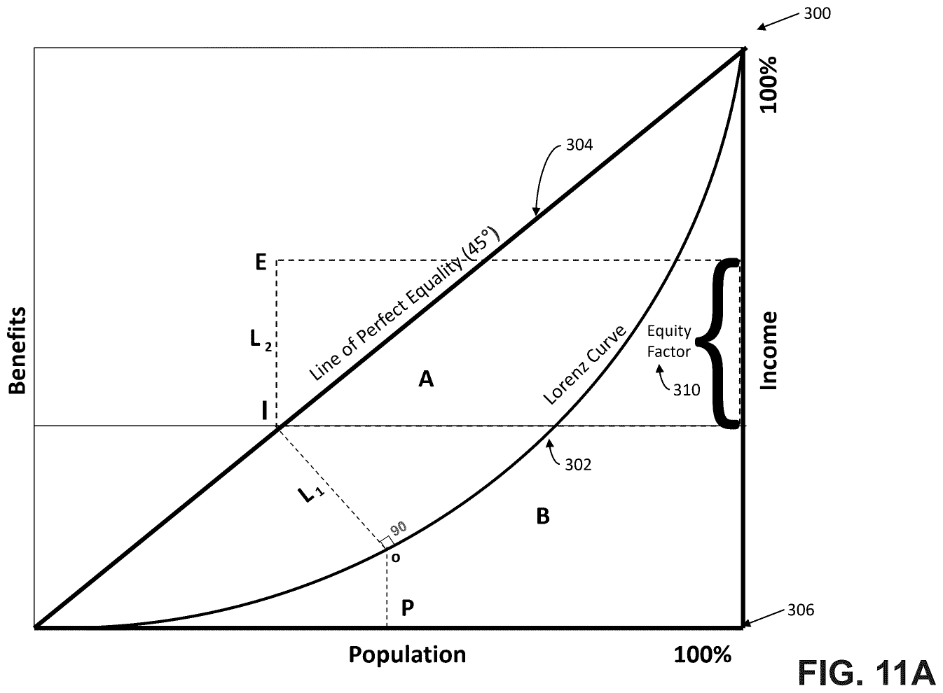

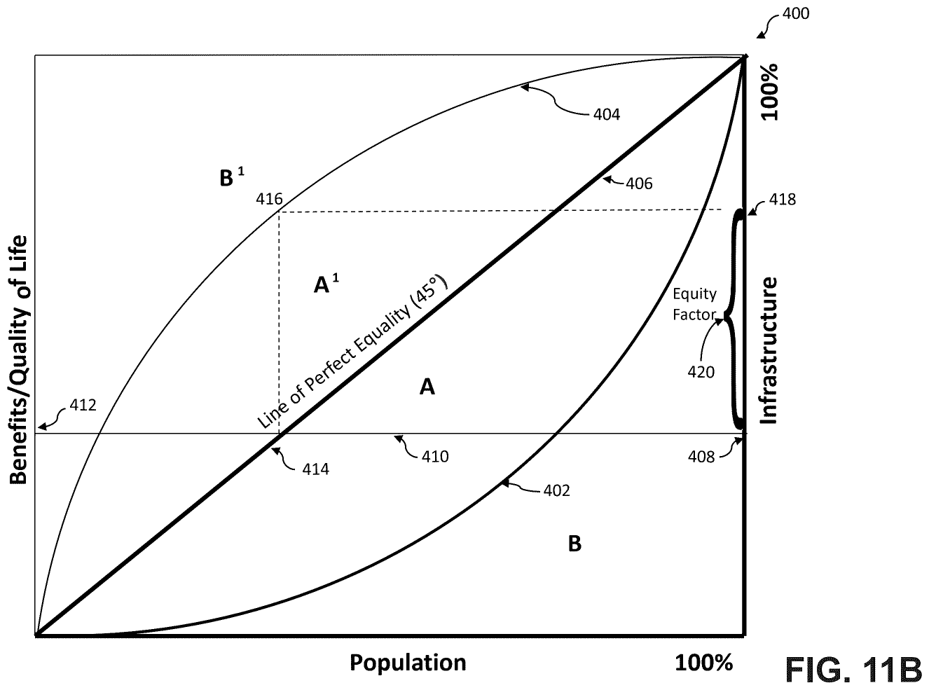

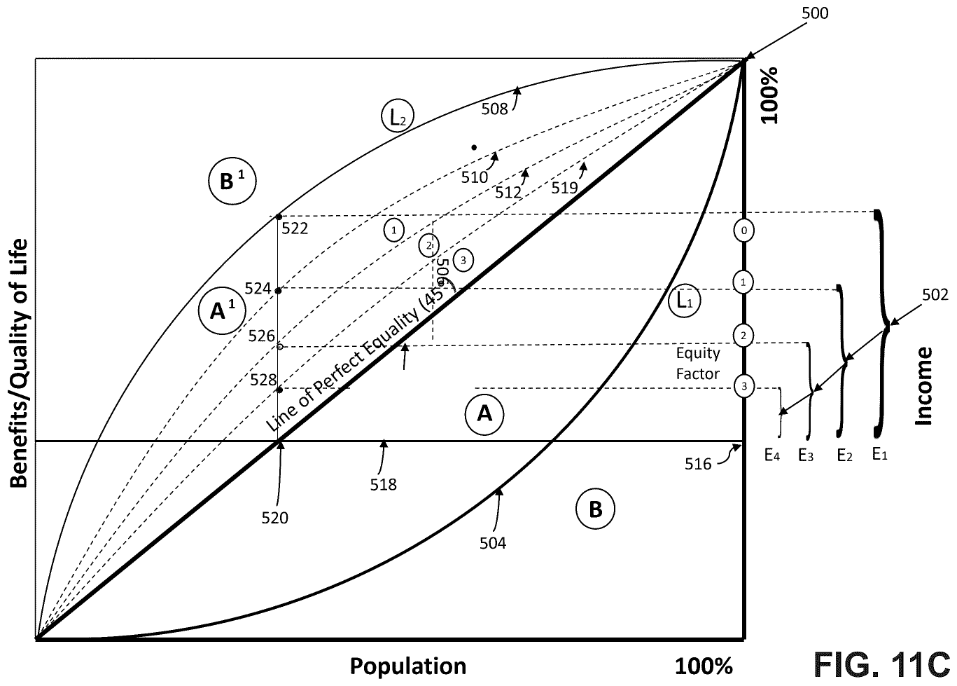

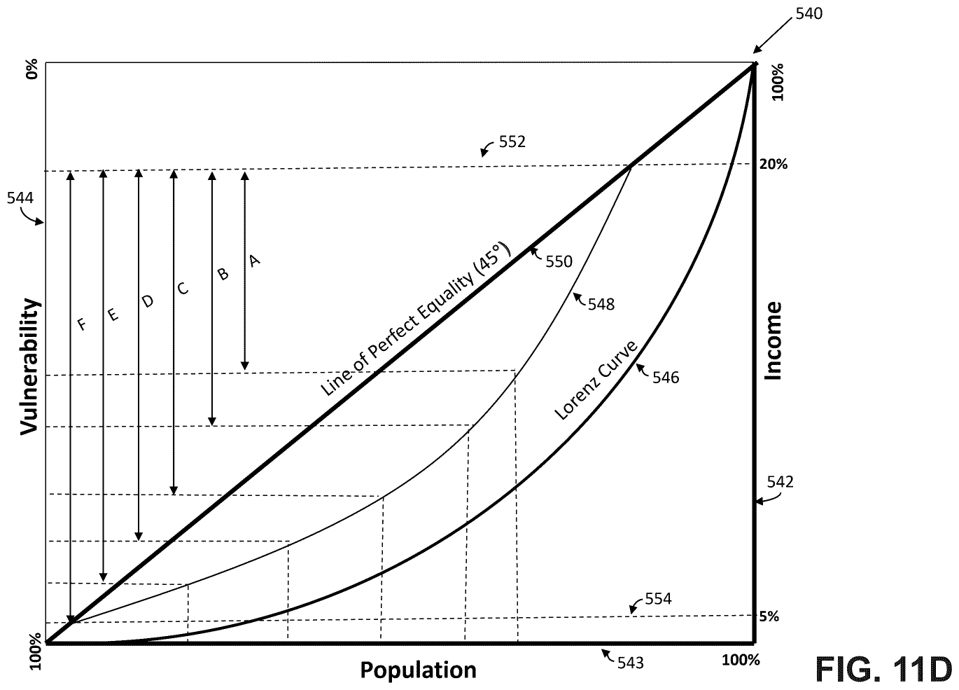

Referring to FIG. 11A, a typical Lorenz curve 300 is shown. As is well known in the art, the Lorenz curve 302 represents a distribution of income or wealth. The curve is used to show the proportion of overall income or wealth held by a given percentage of the population. Specifically, Lorenz curve 302, for example, shows a known or specified percentage of households and the percentage of the total income that is attributable to the group. Line of equality 304 is the ideal income depicting equal income across all percentages of the population. As is well known in the art, the percentage of the population is shown on the X-axis or horizontal axis and the percentage of total income is shown on the Y-axis or the vertical axis.

A perfectly unequal distribution would be one in which one person has all the income and everyone else has none. In that case, the curve would be at y=0%, (at 302) for all x<100%, and y=100% when x=100%, (at 304). This curve is called the “line of perfect inequality.” In sharp contrast, a perfectly equal income distribution” 308 would be one in which every person has the same income. In this case, the bottom P % of society would always have P % of the income. This can be depicted by the straight-line y=x; called the “line of perfect equality” or 45 degrees 308. As is well known in the art the Lorenz curve is a probability curve. It is derived from a probability density function f(x) with the cumulative distribution function F(x), the Lorenz curve L is given by the following equation:

$$L ( F ( x ) ) = \frac{{\int }_{- ∞}^{x} t f ( t ) dt}{{\int }_{- ∞}^{∞} t f ( t ) dt} = \frac{{\int }_{- ∞}^{x} t f ( t ) dt}{μ}$$

Where μ denotes the average. The Lorenz curve L(F) may then be plotted as a function parametric in x: L(x) vs. F(x). In other words, the quantity computed here is known as the length biased (or size biased) distribution. Further, for a cumulative distribution function, F(x) with inverse x(f), the Lorenz curve L(F) is directly given by the following equation.

$$L ( F ) = \frac{{\int }_{0}^{F} x ( {F}_{1} ) {dF}_{1}}{{\int }_{0}^{1} x ( {F}_{1} ) {dF}_{1}}$$

The inverse x(F) may not exist because the cumulative distribution function has intervals of constant values. However, the previous formula can still apply by generalizing the definition of x(F):

x(F₁)=inf {y: F(y)≥F₁}. Accordingly, starting with a set of statistical information for a given population group, the Lorenz curve 306 can be generated using the formulas indicated hereinabove.

Further, in conjunction with the Lorenz curve, the Gini coefficient is used to measure the inequality among a sample of population for a given Lorenz curve 306. The Gini coefficient is the ration of area A over the area covered by A+B. The Gini coefficient can range from 0, which represents complete inequality to 1 which represents complete equality. A well-known mathematical expression for the Gini coefficient is provided herein below:

$$Gini Coefficient = 1 - {\sum }_{m = 1}^{n} ( {X}_{m} - {X}_{m - 1} ) ( {Y}_{m} + {X}_{m - 1} ) = \frac{Area under A}{Area under A + Area under B}$$

With reference to FIG. 11A, the Gini coefficient measures how far Lorenz curve 302 is for a society's income or wealth from the line of equality 304. One of the limitations of the Gini coefficient is that it does not take into consideration some of the structural changes that occur in a population. The Gini coefficient being a relative measure does not always represent the actual condition in a population. For example, it is possible to encounter a Gini coefficient to rise indicating rising inequality of income, while the number of people below a certain poverty level may be decreasing. Accordingly, for example, public and private transportation providers who are vested in the provision of equitable mobility service, should use a different tool to determine the level of support they can provide to a certain group of people in a population such as community envelope 30. Specifically, the present disclosure provides tools to determine adjustment factors related to benefits and or quality of life parameters based on data obtained from a given community envelope 30 or other local, state and or national standards.

Referring to FIG. 11B, a modified dual-Lorenz curve 400 is represented in accordance with the present disclosure. For a given community envelope 30, a Lorenz curve 402, and a companion and inverse curve 404 are generated. The horizontal axis represents the percentage of the population. The Y-Axes represent income on the right side, and benefits and or quality of life measurements, respectively. As discussed hereinabove, line of perfect equality 406 represents a locus of points where any percentage of the population will have an equal income and benefits/quality of life. As an illustrative example, if income is at point 408 and horizontal line 410 is extended from the income axis to the benefits/quality axis, it will intersect with line 406 at point 414. Extending a vertical line from 104 to curve 404, provides a point of intersection at 416. Extending a horizontal line from point 416 to 418 provides an interval or adjustment equity factor 420. While scalar value at 420 represents a maximum adjustment to provide near ideal and equitable distribution of benefits, policy makers may use it as a means to caliber their subjective and objective analysis in allocating resources to effect equitable distribution of benefits. In the alternate this may be used as a tool to project the impact of certain policies and decisions which have direct impact on benefits and quality of life considerations.

FIG. 11C is a depiction of dual Lorenz curves showing varying levels and or different types of benefits under consideration to determine adjustment factors or impacts thereof. Specifically, chart 500 provides a series of equity adjustment factors 502 derived from a reference measurement in relation with Lorenz curve 504, line of perfect equality 506 and a benefits curve 508 derived from existing conditions in a community such as community envelope 30. Several levels of benefits 510, 512, 514 shown in broken line curves, depict various types of policies, projects, investments or improvements relating to a specific-types of benefits or quality of life standards. As an exemplary depiction of how the chart is applied, at income level 516, a horizontal line 518 intersects with curves 504, 506, 508, 510, 512 and 514. Using line of perfect equality 506 as a reference where line 518 intersects with it at 520, a vertical line is generated at the intersection. The vertical line intersects with curves 508 at 522, curve 510 at 524, with curve 512 at 526, and with curve 514 at 528. Extending horizontal lines from these points of intersections on the income axis, a series of equity adjustment factors 502 (shown as E1, E2, E3, E4) can be determined or calculated for each of the curves representing various types of benefits, for example, arising from different policies. In the alternate, the analysis could be used to monitor and assess the impact of a policy if the modified Lorenz curve moves closer to the line of perfect equity 506. For example, a policy which provides communication technology to citizens in community envelope 30 to enable access to home care services, nursing centers, hospitals and clinics, nutrition counselling, public and private transportation services, financial services and education, recreational facilities, individually tailored services based on health conditions and the like could be tracked and evaluated using the modified Lorenz curve of the present disclosure.

Referring to FIG. 11D, a vulnerability assessment tool (VAT) 540 is shown. The tool includes vertical axis 542 and 544, representing income and vulnerability measurement scales respectively. Specifically, income is measured with an increasing scale vertically. In contrast, vulnerability is measured with a descending scale on the opposite vertical axis. As discussed herein above, horizontal axis 543 represents the percentage of population of a community.

An exemplary implementation of VAT 540 for a given episode, crisis, event or economic condition having either a temporary or permanent impact of 20% on the high income group is represented by line 552. The same episode is assumed to have an impact of 95% in the low income population as depicted by line 554.

On the basis of these exemplary parameters, vulnerability curve 548 can be generated. Typically, vulnerability curve 548 spans between the intersection points of 552 and 554 with line of perfect equality 550. More significantly, the point of intersection of line 552 with 550 is used as a fixed point or point of reference to generate vulnerability curve 548. Thus, only the lower end of vulnerability curve 548 exhibits variable values.

A practical implementation of VAT 540 includes use of adjustment factors (lines A, B, C, D, E and F) as shown in FIG. 11D. These adjustment factors influence the span of vulnerability curve 548. For example, as the vulnerability value increases from A to E, the span of vulnerability curve 548 increases. Alternatively, if the vulnerability value decreases moving from E toward A, vulnerability curve 548 approaches line of perfect equality 550. As discussed herein above, with reference to line 550, the impact of an episode will be the same at all income levels for all vulnerability curve values which lie on line 550.

Accordingly, VAT 540 can be integrated with a modified Lorenz curve such as 400 and 500 to provide analytical tools to design an equitable public policy, strategically direct private and public investments and measure their effectiveness in reducing economic and other disparities. Further, VAT 540 in conjunction with the other tools disclosed herein, can be used to address income-based disparities and help design remedial policies and processes with measurable outcomes.

Moreover, using the analytical tools of the present disclosure both community interest groups, public and private entities can be organized to focus on effective means of assessing disparities and providing reliable solutions. Specifically, the tools of the present disclosure enable the assessment of various economic, social and political factors, with a view to implement action plans to attenuate disparities which perpetuate a permanent underclass.

In essence, the present disclosure provides tools to effectively track, adjust and manage public and private investments and policies to enable equitable access to economic opportunities.

One aspect of the present disclosure is to provide public policy and private decision makers with tools to measure the effectiveness of a policy or project to impact equitable access of quality of life of benefits to all citizens. A novel use of the Lorenz curve in conjunction with all the tools disclosed herein provides scalar quantities for measuring the effectiveness of a certain investment or policy over a given time interval. For example, for a given policy or investment if the quality of life and or benefits curves move from 510 to 512 and subsequently to curve 514, the direction of movement is toward line of perfect equality 506 and therefore shows a positive trend of continuous improvement. Similarly if VAT 548 approaches the line of perfect equity 550, and the span continues to decrease, it is a positive indication of progress toward achieving expected equity goals or objective for a given community. In the alternate, a reverse movement in the opposite direction will show a worsening trend. Further, government policy makers and or investors will be able to compare the impact of their decisions on quality of life based on various types of policies or investment actions represented by 510, 512 and 514 with initial curve 508 as a point of reference.

Yet another aspect of the present disclosure is to provide a vulnerability simulation tool for use with the system of the present disclosure to provide a full view of the impact, advantages and disadvantages of policies and developments on community envelope 30. More importantly, the disclosure provides tools to assess, measure and predict the impact, whether it is positive or negative. More importantly the present disclosure provides tools which can be used to rectify or attenuate negative impact of public and private activities and decision which impact community envelope 30, for example. Since vulnerability curve 548 is correlated with Lorenz curve 546, and similarly quality of life or benefits curves 504, 508, 510, 512, 514 are related to a specific Lorenz curve. Accordingly, there is a relationship between vulnerability curve 548, and the other benefits and standard of living adjustment tools as disclosed hereinabove.

Accounting for multiple government policies and investments which translate into various benefits and quality of life standards with multiple inputs and outputs is complex. A modified approach is to extract the poverty indicator from income distribution and define an income value, Y(minimum) on the income axis of the Lorenz curve, and to declare as poor those people with an income that does not exceed it. However, this so-called head-count ratio does not take into account income distribution among individuals in this group.

Specifically, for the same Gini coefficient, the income share of the poorest group in relation to total income can be different. A deeper insight in the structure of the inequality measure is needed. There are a number of indicators capturing the distribution of wealth or income on an aggregate level, including the Gini or Theil indices as a class of statistically based indicators. These indices are closely linked to social welfare functions. Quantities characterizing quality of life such as, without limitation, access to health, transportation or education, for example, are closely correlated with income. Realizing this, the present disclosure utilizes a set-level of income as the basis to measure adjustment equity factors such as 502. Based on a prevailing income condition, and the objectives behind adjustments to equity, various levels of income may be selected to determine equitable adjustment factors for a group of citizens or a community.

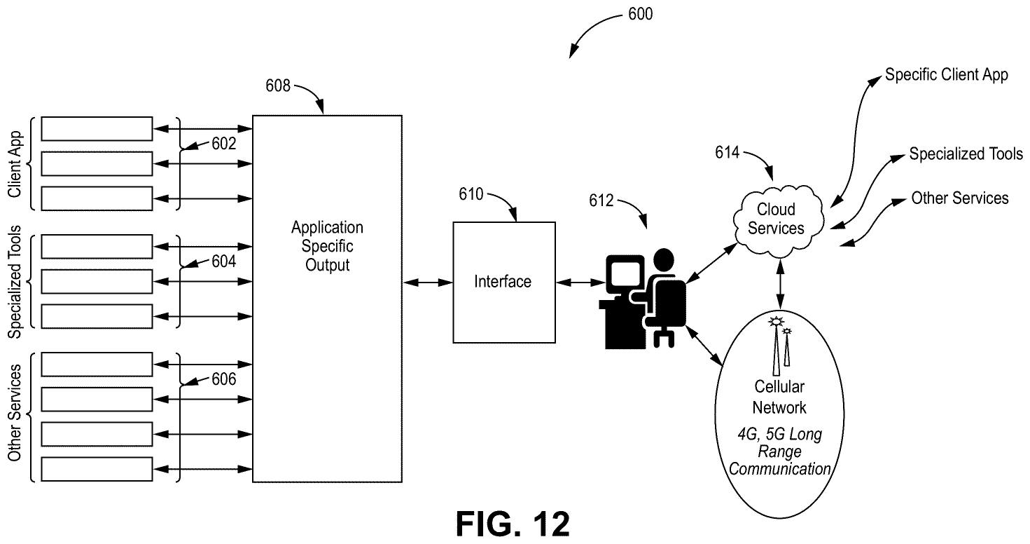

Referring now to FIG. 12, a system configuration to integrate processing outputs for specific applications 600 is shown. Specifically, system operation 18 which includes client application 20, specialized tools 22 and hosted services 24 are clustered into further specific categories to implement an objective based application or end user tools. Under client application 20, various data 602 are clustered that are related to general client applications including, without limitation, general client data based on community envelope 30, an existing or targeted benefit and or quality of life data, and client specific information which some or all of it will be encrypted. A group of Client Application s 602 provide processed intermediate data files extracted from raw data 12, subsequently processed and filtered for storage in memory space 79. Similarly, specialized tools 22 provide processed intermediate files 604 and hosted services 24 is clustered in intermediate file 608. The intermediate data files 602, 604 and 606 are resolved to application-specific output data at 608, respectively. Application-specific data from 608 is prioritized and configured at data interface 610. A plurality of servers provides access to users and system managers via one or more servers 612 which are in bidirectional data communication with interface 610.

With further reference to FIG. 12, clients and third-party users can access specific client data, specialized tools and or output tailored to other services via private, public or hybrid cloud services 614. Cloud services 614 is in a bidirectional data communication with interface 610, servers 612 and cellular network 618. Application specific data output may also be accessed via a cellular network 618, which is in multimodal data communication with cloud services 614 which enables end-users such as clients, to access specialized tools and services as well as public and private parties to modular system 10.

As can be appreciated, the present disclosure provides many advantages with diverse practical applications for its implementation. For example, using geospatial information system (GIS) arising from Community envelope 30, the transportation services, conditions of infrastructure, income of the community, environmental conditions, traffic management systems, community services, schools, hospitals, clinics, places of worship, places of recreation, public parks and related quality of life information including associated social benefits arising from the community assets or lack thereof could be determined and processed through data management system 10. This information coupled with the modified Lorenz curve tool of the present disclosure, and integrated with client information can provide tailored services to members of a community or an individual.

Moreover, community envelope 30 assets needing improvement, redesign or new projects could be targeted to optimize the overall economic and social benefits associated with such projects by taking into consideration all the factors that impact the quality of life of the community. In this regard, the present disclosure provides specialized tools services 22 to enable government, state, city and municipality planners to evaluate and tailor their projects for optimal improvement in the quality of life of community members.

While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of preferred embodiments. Those skilled in the art will envision other modifications within the scope and variants of the claims appended hereto.

What is claimed is:

1. A customizable modular system integrating client applications, specialized tools, and hosted services structured to manage community services and associated infrastructure networks comprising:
data collection tools and transmission platform;
data processing and analysis platform,
automation features based on the data processing and analysis;
AI system integrated with the data processing and analysis platform having features to learn and adapt over time;
user interface tools and enhancement features based on one of smart assistant and IOT devices with edge computing capabilities integrated with the AI system to provide one of tailored suggestions or actions; and
wherein the customizable modular system including the data collection tools and transmission platforms, the data processing and analysis platform, the automation features, the AI system, the user interface tools and enhancement features collaborate to form a holistic systems architecture of the modular system.

2. The system according to claim 1, further comprising a customization platform within the specialized tools, designed to assimilate and process new data from a dynamically changing environment and to aid in the evaluation and follow-up of the public and private investments and policies.

3. The modular system according to claim 1, wherein the user interface tools include interactive tools tailored to residents of a specific community, enabling operation of system tools and integration with personal assistant devices.

4. The system according to claim 1, wherein the specialized tools include a modified Lorenz curve and vulnerability simulation tools (VST) for designing, tracking, and monitoring policy effectiveness in enhancing equity and improving living standards in various communities.

5. The system according to claim 1, wherein the hosted services platform is structured to enable third-party service providers to engage with and utilize the modular system tools and platform for delivering services related to transportation, healthcare, and similar tailored client-specific services.

6. The system according to claim 1, wherein the AI-enabled application supports real-time, dynamic learning and adaptation to individual client interactions, facilitating equitable and effective policy and investment decisions.

7. A customizable data processing and service provision system comprising:
A data processing module and architecture configured for:
a) collecting data from a defined geographical community envelope;
b) customizing the collected data to reflect current observed changes;
c) integrating the customized data into client applications and third-party services;
d) using the data to inform and guide an equitable provision of services and benefits based on community-specific needs; and
Wherein the system being operable to provide tailored services using the data processing module to integrate specialized tools such as middleware for bridging between different systems and applications facilitating communication and data exchange, APIs (application programming interface), edge-to-cloud integration with IOT devices, integration of AI models and algorithms, IOT platform integration, event driven architecture for active IOT events and data stream analysis in real time, and interoperability features to form a holistic architecture of the system.

8. The system of claim 7, wherein the community envelope data includes income, transportation, healthcare, housing standards, environmental safety data, and related quality of life parameters.

9. The system of claim 7, further comprising a module for assessing and allocating resources based on building density regulations and urban design within community zones.

10. The system of claim 7, wherein the client application is structured to provide individual applications tailored to the needs of residents based on community envelope data.

11. The system of claim 7, further including a feature for third-party service providers to access customized data under hosted services.

12. The system of claim 7, where the system utilizes a modified Lorenz curve to evaluate and design systems for equitable access to a targeted standard of living.

13. A modular digital system operable for providing equitable access to standard of living improvements, comprising:
collecting community data through a modular digital system;
analyzing the data using modified Lorenz curves and vulnerability metrics;
integrating AI and IoT for real-time data processing and application;
customizing access to services based on client-specific needs;
utilizing hosted service platforms for comprehensive policy development; and
implementing dynamic learning algorithms for system adaptation.

14. The method of claim 13, wherein collecting community data includes gathering from public and private information sources.

15. The method of claim 13, further comprising the step of updating the Lorenz curves based on historical and current socio-economic data.

16. The method of claim 13, wherein AI and IoT integration assists in traffic and public transport management.

17. The method of claim 13, wherein customization is based on socio-economic, community zones and geographic factors.

18. The method of claim 13, wherein hosted service platforms facilitate cross-sector collaboration between various public and social services.

19. The method of claim 13, wherein dynamic learning algorithms are applied for predictive modeling of public and social infrastructure requirements based on.

20. The method of claim 13, wherein the modular system incorporates cloud computing, real-time data processing, and predictive analytics for proactive policy making and service management.
